(19) United States
(12) Patent Application Publication
(10) Pub. No.: US 2017/0128889 A1
(43) Pub. Date: May 11, 2017

(54) FILTRATION APPARATUS, AND IMMERSION-TYPE FILTRATION METHOD USING SAME

(71) Applicant: SUMITOMO ELECTRIC INDUSTRIES, LTD., Osaka-shi, Osaka (JP)

(72) Inventors: Hiromu TANAKA, Osaka (JP); Toru MORITA, Osaka (JP)

(21) Appl. No.: 15/039,042

(22) PCT Filed: Mar. 3, 2015
(86) PCT No.: PCT/JP2015/056132

§ 371 Date: May 25, 2016

(30) Foreign Application Priority Data
Mar. 17, 2014 (JP) 2014-053668

(51) Int. Cl. B01D 65/02; C02F 1/44; B01D 63/02

(52) U.S. Cl. CPC B01D 65/02; B01D 63/02; C02F 1/44; B01D 2315/06; B01D 2317/02; B01D 2321/185; C02F 2103/002

(57) ABSTRACT

A filtration apparatus and an immersion-type filtration method using the same having excellent treatment efficiency and cost performance are provided. The filtration apparatus of the present invention is an immersion-type filtration apparatus that purifies a liquid to be treated by using a filtration membrane, and includes a plurality of filtration units each including a filtration vessel and at least one filtration membrane module immersed in the filtration vessel, the filtration units being arranged in series. The liquid to be treated is preferably supplied from an upstream filtration unit to a downstream filtration unit of the filtration apparatus by causing the liquid to be treated to overflow. An air bubble supplying unit that supplies air bubbles from under the filtration membrane module is preferably provided. The immersion-type filtration method of the present invention uses this filtration apparatus and purifies the liquid to be treated by supplying a portion of the liquid to be treated in the upstream filtration unit to the downstream filtration unit.

### TECHNICAL FIELD

The present invention relates to a filtration apparatus and an immersion-type filtration method using the same.

### BACKGROUND ART

Filtration apparatuses that use filtration membranes (for example, refer to Japanese Unexamined Patent Application Publication No. 2010-42329) that mainly pass only water are used as filtration apparatuses in wastewater treatment and pharmaceutical manufacturing processes, for example. Such filtration apparatuses are available as external-pressure type apparatuses in which a liquid to be treated is induced to permeate into a filtration membrane by osmotic pressure or by increasing the pressure on the outer side of the filtration membrane or decreasing the pressure on the inner side of the filtration membrane, and internal-pressure type apparatuses in which a liquid to be treated is induced to permeate out from the filtration membrane by increasing the pressure on the inner side of the filtration membrane.

### CITATION LIST

### Patent Literature

NPL 1: Japanese Unexamined Patent Application Publication No. 2010-42329

### SUMMARY OF INVENTION

### Technical Problem

Among the filtration apparatuses described above, immersion-type apparatuses undergo significant degradation of filtration membrane filtration capabilities when the concentration of separated substances inside the filtration vessel increases with the progress of the filtration treatment. Thus, according to a conventional filtration apparatus, it is necessary to extend the treatment time or increase the area of the filtration membrane in order to separate a particular amount of water from the liquid to be treated, and it is thus difficult to improve the treatment efficiency and decrease the cost simultaneously.

The present invention has been made under these circumstances and aims to provide a filtration apparatus that offers excellent treatment efficiency and cost performance and an immersion-type filtration method that uses the filtration apparatus.

### Solution to Problem

The invention made to address the issues described above provides a filtration apparatus of an immersion type that purifies a liquid to be treated by using a filtration membrane, the filtration apparatus comprising a plurality of filtration units each comprising a filtration vessel and at least one filtration membrane module immersed in the filtration vessel, the filtration units being arranged in series.

Another invention made to address the issues described above includes using the filtration apparatus described above, in which a portion of a liquid to be treated in an upstream filtration unit is supplied to a downstream filtration unit among the plurality of filtration units so as to purify the liquid to be treated.

### Advantageous Effects of Invention

The filtration apparatus of the present invention has excellent treatment efficiency and cost performance. Thus, the filtration apparatus and the immersion-type filtration method using the filtration apparatus according to the present invention can be used to efficiently separate a liquid to be treated, for example, a liquid containing oil and the like.

### BRIEF DESCRIPTION OF DRAWINGS

FIG. 1 is a schematic diagram illustrating a filtration apparatus according to one embodiment of the present invention.

FIG. 2 is a schematic diagram illustrating a filtration apparatus according to an embodiment of the present invention different from the embodiment illustrated in FIG. 1.

### DESCRIPTION OF EMBODIMENTS

### [Description of Embodiments of the Invention of the Subject Application]

The invention of the subject application provides an immersion-type filtration apparatus that purifies a liquid to be treated by using a filtration membrane and includes a plurality of filtration units each comprising a filtration vessel and at least one filtration membrane module immersed in the filtration vessel, the filtration units being arranged in series.

Since the filtration apparatus treats water through a plurality of filtration units connected in series, filtration can be conducted by efficiently distributing the amount of the liquid to be treated and the concentration of the separated substances inside the filtration vessel of each filtration unit. In other words, according to this filtration apparatus, filtration can be conducted while maintaining the filtration capabilities of the filtration membrane modules in the respective filtration vessels at an appropriate level; hence, water can be treated efficiently by decreasing the filtration areas of the filtration membrane modules and cutting the cost.

The liquid to be treated is preferably supplied from the filtration unit upstream to the filtration unit downstream by causing the liquid to overflow. When the liquid to be treated is supplied between filtration units by being caused to overflow, the amount of the liquid to be treated supplied to the filtration vessel downstream can be easily and unfailingly controlled. As a result, the water treatment efficiency can be further improved.

Preferably, an air bubble supplying unit that supplies air bubbles from under the filtration membrane module is further provided. When an air bubble supplying unit is provided, the filtration capabilities of the filtration membrane modules of each filtration unit can be maintained and thus the water treatment efficiency can be further enhanced. In particular, according to this filtration apparatus, the amount of the liquid treated in each filtration unit can be decreased compared to conventional filtration apparatuses and thus the filtration membranes can be more efficiently cleaned by using the air bubble supplying unit.

The invention of the subject application also provides an immersion-type filtration method that uses the filtration apparatus described above, the method including supplying a portion of a liquid to be treated in the filtration unit upstream to the filtration unit downstream to purify the liquid to be treated.

According to the immersion-type filtration method, the liquid to be treated is treated by using the filtration apparatus; thus, the liquid to be treated can be purified at high efficiency and a low cost.

### [Details of the Embodiments of the Invention of the Subject Application]

The filtration apparatus and the immersion-type filtration method according to the present invention will now be described in detail with reference to the drawings.

### <Filtration Apparatus>

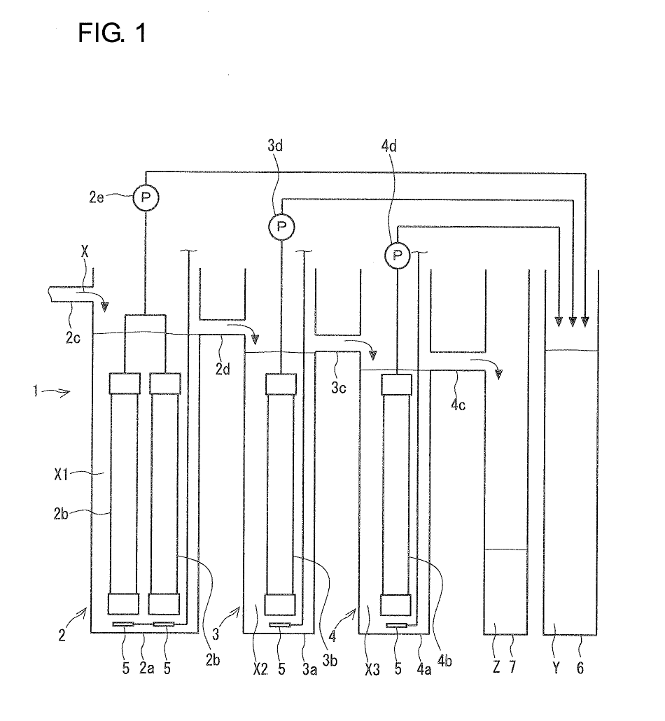

A filtration apparatus 1 shown in FIG. 1 includes a first filtration unit 2 to which a liquid to be treated X is supplied, a second filtration unit 3 to which a portion of a liquid to be treated X1 in the first filtration unit 2 is supplied, and a third filtration unit 4 to which a portion of a liquid to be treated X2 in the second filtration unit 3 is supplied. The first filtration unit 2, the second filtration unit 3, and the third filtration unit 4 are arranged in series. The first filtration unit 2 includes a first filtration vessel 2a and first filtration membrane modules 2b immersed in the first filtration vessel 2a. The second filtration unit 3 includes a second filtration vessel 3a and a second filtration membrane module 3b immersed in the second filtration vessel 3a. The third filtration unit 4 includes a third filtration vessel 4a and a third filtration membrane module 4b immersed in the third filtration vessel 4a. The filtration apparatus 1 further includes air bubble supplying units 5 that supply air bubbles from under the first filtration membrane modules 2b, the second filtration membrane module 3b, and the third filtration membrane module 4b, a treated liquid storage vessel 6 that stores a treated liquid Y, and a concentrated liquid storage vessel 7 that stores a concentrated liquid Z. The filtration apparatus 1 is an immersion-type filtration apparatus that purifies a liquid to be treated by arranging three filtration units in series, each filtration unit having at least one filtration membrane module immersed in the liquid to be treated.

### (First Filtration Unit)

The first filtration unit 2 is the uppermost-stream (upstream) filtration unit in the filtration apparatus and is the filtration unit to which the liquid to be treated X is supplied first. The first filtration unit 2 includes the first filtration vessel 2a and the first filtration membrane modules 2b immersed in the first filtration vessel 2a, as described above.

### (First Filtration Vessel)

The first filtration vessel 2a is a container that can store liquid inside. The first filtration vessel 2a is a bottomed cylindrical member having an open upper end. The planar shape of the first filtration vessel 2a is not particularly limited and may be, for example, circular or polygonal. Two first filtration membrane modules 2b are disposed inside the first filtration vessel 2a. A liquid supplying pipe 2c that supplies the liquid to be treated X is connected to an upper portion of the first filtration vessel 2a, and a first overflow pipe 2d is connected at a position lower than the liquid supplying pipe 2c. Once the liquid level of the liquid to be treated X1 inside the first filtration vessel 2a reaches the first overflow pipe 2d, the liquid to be treated X1 overflows and is supplied to the second filtration vessel 3a through the first overflow pipe 2d. Alternatively, the liquid to be treated X may be directly supplied to the first filtration vessel 2a from the open end of the first filtration vessel 2a without using the liquid supplying pipe 2c.

### (First Filtration Membrane Modules)

The first filtration membrane modules 2b each have filtration membranes that are aligned to be parallel to each other in an upward-downward direction, and a holding member that fixes one or both ends of the filtration membranes. The filtration membranes may be any membranes that allow water to permeate into hollow parts inside and prevent permeation of particles of separated substances and the like contained in the liquid to be treated X. For example, known porous hollow fiber membranes and flat membrane elements and the like can be used.

As the hollow fiber membranes, those mainly composed of thermoplastic resin can be used. Examples of the thermoplastic resin include polyethylene, polypropylene, polyvinylidene fluoride, ethylene-vinyl alcohol copolymers, polyamide, polyimide, polyether imide, polystyrene, polysulfone, polyvinyl alcohol, polyphenylene ether, polyphenylene sulfide, cellulose acetate, polyacrylonitrile, and polytetrafluoroethylene (PTFE). Among these, PTFE, which has excellent chemical resistance, heat resistance, weather resistance, flame retardancy, etc., and is porous, is preferable. Uniaxially or biaxially stretched PTFE is more preferable. Additives and the like such as other polymers, a lubricant, etc., may be added to a material for forming hollow fiber membranes.

The hollow fiber membrane preferably has a multilayer structure in order to achieve both water permeability and mechanical strength and enhance the surface cleaning effect of air bubbles. Specifically, the hollow fiber membrane preferably includes a support layer on the inner side and a filtration layer stacked on a surface of the support layer.

The average thickness of the support layer of the hollow fiber membrane is, for example, 0.1 mm or more and 3 mm or less. When the average thickness of the support layer is within this range, mechanical strength and water permeability can be imparted to the hollow fiber membrane in a well-balanced manner. The average thickness of the filtration layer of the hollow fiber membrane is, for example, 5 μm or more and 100 μm or less. When the average thickness of the filtration layer is within this range, high filtration performance can be easily and unfailingly imparted to the hollow fiber membrane.

The average outer diameter of the hollow fiber membrane is, for example, 2 mm or more and 6 mm or less and the average inner diameter is, for example, 0.5 mm or more and 4 mm or less. The average length of the hollow fiber membrane can be appropriately designed according to the size and treatment amount of the first filtration vessel 2a.

An example of the flat membrane element is a flat membrane element that includes a membrane body formed of a resin sheet such as porous PTFE folded so that one of the surfaces has parts facing each other, a support member formed of a net composed of resin such as polyethylene and interposed between the parts of the membrane body facing each other, and an outer periphery sealing member that seals an outer peripheral edge of the membrane body in the folded state. The membrane body is placed with the folded part down and the open portion fixed to a header so that channels for the treated liquid are formed inside.

The membrane body of the flat membrane element may be a single layer or a multilayer. The membrane body preferably has pores 0.01 μm or larger and 20 μm or smaller, has a particle capture rate of 90% or higher for particles having a particle diameter of 0.45 μm, has an average membrane thickness of 5 μm or more and 200 μm or less, and has a fiber skeleton having an average maximum length of 5 μm or less, the fiber skeleton surrounding the pores.

The holding members at the upper portions of the first filtration membrane modules 2b each have a drain unit (water collecting header) that collects the liquid that has permeated through the filtration membrane. A drain pipe is connected to the drain unit, and the filtrated liquid (treated liquid Y) is drained from the first filtration membrane module 2b by suction of a first pump 2e and transferred to the treated liquid storage vessel 6.

### (Air Bubble Supplying Units)

The air bubble supplying units 5 supply air bubbles that clean the surfaces of the filtration membranes. The air bubbles are supplied from under the first filtration membrane modules 2b, and the second filtration membrane module 3b and the third filtration membrane module 4b described below. The air bubbles clean the surfaces of the filtration membranes as they move upward while scrubbing the surfaces of the filtration membranes.

The air bubble supplying units 5 that supply air bubbles to the first filtration membrane modules 2b are immersed, together with the first filtration membrane modules 2b, in the first filtration vessel 2a storing the liquid to be treated X1. The air bubble supplying units 5 supply air bubbles by continuously or intermittently discharging gas supplied through an air supply pipe from a compressor or the like. The air bubble supplying units 5 that supply air bubbles to the second filtration membrane module 3b and the third filtration membrane module 4b are identical to the air bubble supplying units 5 that supply air bubbles to the first filtration membrane modules 2b. The air bubble supplying units 5 are not particularly limited, and known gas diffusers can be used. Examples of the gas diffusers include gas diffusers that use perforated plates or perforated pipes formed by forming a large number of pores in resin or ceramic plates or pipes, jet-type gas diffusers that jet gas from diffusers and spargers, and intermittent bubble-jet-type gas diffusers that jet air bubbles intermittently.

The gas supplied from the air bubble supplying units 5 may be any inactive gas. From the viewpoint of running cost, air is preferably used.

### (Second Filtration Unit)

The second filtration unit 3 is disposed at the downstream of the first filtration unit 2 and is a filtration unit to which a portion of the liquid to be treated X1 in the first filtration unit 2 is supplied. The second filtration unit 3 includes the second filtration vessel 3a and the second filtration membrane module 3b immersed in the second filtration vessel 3a, as described above.

### (Second Filtration Vessel)

The second filtration vessel 3a is, as with the first filtration vessel 2a, a bottomed cylindrical container that can store liquid inside and has an open upper end. A second filtration membrane module 3b is disposed inside the second filtration vessel 3a. A first overflow pipe 2d that supplies a portion of the liquid to be treated X1 in the first filtration vessel 2a is connected to an upper portion of the second filtration vessel 3a, and a second overflow pipe 3c is connected at a position lower than the first overflow pipe 2d. When the liquid level of the liquid to be treated X2 in the second filtration vessel 3a reaches the second overflow pipe 3c, the liquid to be treated X2 overflows and is supplied to the third filtration vessel 4a through the second overflow pipe 3c.

The amount of the liquid to be treated X1 supplied to the second filtration vessel 3a is smaller than the amount of the liquid to be treated X supplied to the first filtration vessel 2a; thus, the volume of the second filtration vessel 3a can be designed to be smaller than the volume of the first filtration vessel 2a.

The upper limit of the amount of the liquid to be treated X1 overflowing and supplied from the first filtration vessel 2a to the second filtration vessel 3a is preferably 60% by mass and more preferably 55% by mass of the amount of the liquid to be treated X supplied to the first filtration vessel 2a. The lower limit of the amount of the liquid supplied is 40% by mass and more preferably 45% by mass of the amount of the liquid to be treated X supplied to the first filtration vessel 2a. When the amount supplied exceeds the upper limit described above, the treatment load at the second filtration vessel 3a increases and the treatment efficiency of the filtration apparatus 1 may decrease. Conversely, when the amount supplied is less than the lower limit described above, the treatment load at the first filtration vessel 2a increases and the treatment efficiency of the filtration apparatus 1 may decrease. The amount supplied can be controlled by adjusting the height at which the first overflow pipe 2d is installed, the amount of suction of the first pump 2e, etc., for example.

### (Second Filtration Membrane Module)

The second filtration membrane module 3b can be similar to the first filtration membrane modules 2b.

A drain pipe is connected to a drain unit at an upper portion of the second filtration membrane module 3b, and the filtrated liquid (treated liquid Y) is drained from the second filtration membrane module 3b by suction of a second pump 3d and transferred to the treated liquid storage vessel 6.

The number of second filtration membrane modules 3b inside the second filtration vessel 3a is smaller than (or a half of) the number of first filtration membrane modules 2b inside the first filtration vessel 2a. Thus, the total filtration area (total filtration area of the second filtration unit 3) of the second filtration membrane module 3b inside the second filtration vessel 3a is smaller than the total filtration area (total filtration area of the first filtration unit 2) of the first filtration membrane modules 2b inside the first filtration vessel 2a. The amount of the liquid to be treated X1 supplied to the second filtration vessel 3a is smaller than the amount of the liquid to be treated X supplied to the first filtration vessel 2a; thus, the amount (treatment amount) of the treated liquid Y drained by the second pump 3d is also small. Accordingly, the total filtration area of the filtration membrane modules of the second filtration unit 3 can be designed to be smaller than that of the first filtration unit 2. The concentration of the separated substances in the liquid to be treated X1 supplied to the second filtration vessel 3a is higher than the concentration of the separated substances in the liquid to be treated X supplied to the first filtration vessel 2a; however, it is assumed that since the treatment amount is small, the decrease in the treatment performance of the filtration membrane module is cancelled off The phrase “total filtration area of the filtration unit” means a total of surface areas of filtration membranes in all filtration membrane modules of that filtration unit.

### (Third Filtration Unit)

The third filtration unit 4 is disposed at the downstream of the second filtration unit 3 and is a filtration unit to which a portion of the liquid to be treated X2 in the second filtration unit 3 is supplied. The third filtration unit 4 includes the third filtration vessel 4a and the third filtration membrane module 4b immersed in the third filtration vessel 4a, as described above.

### (Third Filtration Vessel)

As with the first filtration vessel 2a, the third filtration vessel 4a is a bottomed cylindrical container that can store liquid inside and has an open upper end. One third filtration membrane module 4b is disposed inside the third filtration vessel 4a. A second overflow pipe 3c that supplies a portion of the liquid to be treated X2 in the second filtration vessel 3a is connected to an upper portion of the third filtration vessel 4a, and a third overflow pipe 4c is connected at a position lower than the second overflow pipe 3c. When the liquid level of the liquid to be treated X3 in the third filtration vessel 4a reaches the third overflow pipe 4c, the liquid to be treated X3 overflows and is supplied to the concentrated liquid storage vessel 7 through the third overflow pipe 4c.

The amount of the liquid to be treated X2 supplied to the third filtration vessel 4a is smaller than the amount of the liquid to be treated X1 supplied to the second filtration vessel 3a. Thus, the volume of the third filtration vessel 4a can be designed to be smaller than the volume of the second filtration vessel 3a.

The upper limit of the amount of the liquid to be treated X2 overflowing and supplied from the second filtration vessel 3a to the third filtration vessel 4a is preferably 60% by mass and more preferably 55% by mass of the amount of the liquid to be treated X1 supplied to the second filtration vessel 3a. The lower limit of the amount of the liquid supplied is 40% by mass and more preferably 45% by mass of the amount of the liquid to be treated X1 supplied to the second filtration vessel 3a. When the amount supplied exceeds the upper limit described above, the treatment load at the third filtration vessel 4a increases and the treatment efficiency of the filtration apparatus 1 may decrease. Conversely, when the amount supplied is less than the lower limit described above, the treatment load at the second filtration vessel 3a increases and the treatment efficiency of the filtration apparatus 1 may decrease. The amount supplied can be controlled by adjusting the height at which the second overflow pipe 3c is installed, the amount of suction of the second pump 3d, etc., for example.

### (Third Filtration Membrane Module)

The third filtration membrane module 4b can be similar to the first filtration membrane modules 2b.

A drain pipe is connected to a drain unit at an upper portion of the third filtration membrane module 4b, and the filtrated liquid (treated liquid Y) is drained from the third filtration membrane module 4b by suction of a third pump 4d and transferred to the treated liquid storage vessel 6.

The number of third filtration membrane modules 4b inside the third filtration vessel 4a is equal to the number of the second filtration membrane modules 3b inside the second filtration vessel 3a (the number is 1 each). Thus, the total filtration area (total filtration area of the third filtration unit 4) of the third filtration membrane module 4b inside the third filtration vessel 4a is equal to the total filtration area of the second filtration membrane module 3b inside the second filtration vessel 3a. However, since the amount of the liquid to be treated X2 supplied to the third filtration vessel 4a is smaller than the amount of the liquid to be treated X1 supplied to the second filtration vessel 3a, the amount (treatment amount) of the treated liquid Y drained by the third pump 4d is also small. Thus, the total filtration area of the third filtration membrane module 4b inside the third filtration vessel 4a may be designed to be smaller than the total filtration area of the second filtration membrane module 3b inside the second filtration vessel 3a by decreasing the size of the third filtration membrane module 4b, etc.

### <Advantages>

The filtration apparatus 1 treats water by using the first filtration vessel 2a to which the liquid to be treated X is supplied first, the second filtration vessel 3a to which a portion of the liquid to be treated X1 in the first filtration vessel 2a is supplied, and a third filtration vessel 4a to which a portion of the liquid to be treated X2 in the second filtration vessel 3a is supplied. Thus, the concentration of the separated substances in the liquid to be treated X1 in the first filtration vessel 2a can be controlled to a relatively low level, and filtration can be conducted while preventing an increase in concentration of the separated substances in the second filtration vessel 3a. In other words, since the filtration apparatus 1 can perform filtration while maintaining the filtration capabilities of the filtration membrane modules in the respective vessels to an appropriate level, water treatment can be performed efficiently at low cost by decreasing the filtration areas of the filtration membrane modules.

Moreover, according to the filtration apparatus 1, the liquid to be treated in the first filtration vessel 2a and the liquid to be treated in the second filtration vessel 3a can be respectively supplied to the second filtration vessel 3a and the third filtration vessel 4a by causing overflow; thus, the amounts of the liquid to be treated supplied to the second filtration vessel 3a and the third filtration vessel 4a can be easily and unfailingly controlled. Furthermore, since the total filtration area of the second filtration vessel 3a is smaller than the total filtration area of the first filtration vessel 2a, the filtration apparatus 1 offers excellent cost performance.

Since the filtration apparatus 1 includes air bubble supplying units 5 that supply air bubbles from under the respective filtration membrane modules, the filtration capabilities of the filtration membrane modules can be maintained and water treatment efficiency can be further enhanced.

### <Immersion-Type Filtration Method>

According to the immersion-type filtration method, a liquid to be treated is purified by using this filtration apparatus 1, in other words, an apparatus that includes plural filtration units arranged in series. The immersion-type filtration method is described in specific detail below.

First, in the first filtration vessel 2a of the first filtration unit 2, while the liquid to be treated X is being supplied to the first filtration vessel 2a, the treated liquid Y is suctioned by decreasing the pressure on the inner side of the filtration membranes of the first filtration membrane modules 2b by using the first pump 2e, and transferred to the treated liquid storage vessel 6. The amount Q2 of the treated liquid Y to be suctioned is controlled to be smaller than the amount Q1 of the liquid to be treated X supplied to the first filtration vessel 2a. The upper limit of the amount Q2 suctioned is preferably 60% by mass and more preferably 55% by mass of the amount Q1 of the liquid to be treated X supplied to the first filtration vessel 2a. The lower limit of the amount Q2 suctioned is preferably 40% by mass and more preferably 45% by mass of the amount Q1 of the liquid to be treated X supplied to the first filtration vessel 2a. When the amount Q2 suctioned exceeds the upper limit, the treatment load at the first filtration vessel 2a increases and the treatment efficiency of the filtration apparatus 1 may decrease. Conversely, when the amount Q2 suctioned is less than the lower limit, the treatment load at the downstream filtration vessel (the second filtration vessel 3a or the third filtration vessel 4a) increases, and the treatment efficiency of the filtration apparatus 1 may decrease.

As described above, the amount Q2 of the treated liquid Y suctioned in the first filtration vessel 2a is smaller than the amount Q1 of the liquid to be treated X supplied to the first filtration vessel 2a. Thus, the difference (Q1−Q2) overflows into the second filtration vessel 3a through the first overflow pipe 2d. The overflowed liquid to be treated X1 has a higher concentration of the separated substances than the liquid to be treated X supplied to the first filtration vessel 2a. For example, when the amount Q2 suctioned is 50% by mass of the amount Q1 of the liquid to be treated X supplied to the first filtration vessel 2a, the concentration of the separated substances in the overflowed liquid to be treated X1 is estimated to be about twice the concentration of the separated substances in the liquid to be treated X supplied to the first filtration vessel 2a.

Next, in the second filtration vessel 3a of the second filtration unit 3, the treated liquid Y is suctioned by decreasing the pressure on the inner side of the filtration membranes of the second filtration membrane module 3b by using the second pump 3d, and transferred to the treated liquid storage vessel 6. During this process, the amount Q3 of the treated liquid Y suctioned is controlled to be smaller than the amount (Q1−Q2) of the liquid to be treated X1 supplied to the second filtration vessel 3a. The upper limit of the amount Q3 suctioned is preferably 60% by mass and more preferably 55% by mass of the amount (Q1−Q2) of the liquid to be treated X1 supplied to the second filtration vessel 3a. The lower limit of the amount Q3 suctioned is preferably 40% by mass and more preferably 45% by mass of the amount (Q1−Q2) of the liquid to be treated X1 supplied to the second filtration vessel 3a. When the amount Q3 suctioned exceeds the upper limit, the treatment load at the second filtration vessel 3a increases and the treatment efficiency of the filtration apparatus 1 may decrease. Conversely, when the amount Q3 suctioned is less than the lower limit, the treatment load at the downstream filtration vessel (the third filtration vessel 4a) increases, and the treatment efficiency of the filtration apparatus 1 may decrease.

As described above, the amount Q3 of the treated liquid Y suctioned in the second filtration vessel 3a is smaller than the amount (Q1−Q2) of the liquid to be treated X1 supplied to the second filtration membrane 3. Thus, the difference (Q1−Q2−Q3) overflows into the third filtration vessel 4a through the second overflow pipe 3c. The concentration of the separated substances in the overflowed liquid to be treated X2 is higher than that in the liquid to be treated X1 supplied to the second filtration vessel 3a.

Lastly, in the third filtration vessel 4a of the third filtration unit 4, the treated liquid Y is suctioned by decreasing the pressure on the inner side of the filtration membranes of the third filtration membrane module 4b by using the third pump 4d, and transferred to the treated liquid storage vessel 6. During this process, the amount Q4 of the treated liquid Y suctioned is controlled to be smaller than the amount (Q1−Q2−Q3) of the liquid to be treated X2 supplied to the third filtration vessel 4a. The upper limit of the amount Q4 suctioned is preferably 60% by mass and more preferably 55% by mass of the amount (Q1−Q2−Q3) of the liquid to be treated X2 supplied to the third filtration vessel 4a. The lower limit of the amount Q4 suctioned is preferably 40% by mass and more preferably 45% by mass of the amount (Q1−Q2−Q3) of the liquid to be treated X2 supplied to the third filtration vessel 4a. When the amount Q4 suctioned exceeds the upper limit, the treatment load at the third filtration vessel 4a increases and the treatment efficiency of the filtration apparatus 1 may decrease. Conversely, when the amount Q4 suctioned is less than the lower limit, the treatment amount of the filtration apparatus 1 decreases.

As described above, since the amount Q4 of the treated liquid Y suctioned in the third filtration vessel 4a is smaller than the amount (Q1−Q2−Q3) of the liquid to be treated X2 supplied to the third filtration vessel 4a, the difference (Q1−Q2−Q3−Q4) overflows into the concentrated liquid storage vessel 7 through the third overflow pipe 4c.

As a result, the purified treated liquid Y is stored in the treated liquid storage vessel 6 and a concentrated liquid Z having a high separated substance concentration is stored in the concentrated liquid storage vessel 7. The treated liquid Y and the concentrated liquid Z are utilized or disposed of in appropriate ways.

Examples of the specific usage of the immersion-type filtration method include sewage treatment, industrial drainage treatment, filtration for industrial water, treatment of water used to wash machines etc., filtration of swimming pool water, filtration of river water, filtration of seawater, sterilization or clarification for fermentation processes (enzymatic or amino acid purification), filtration of food, sake, beer, wine, etc. (in particular, raw products), separation of bacterial cells from fermenters in drug making or the like, filtration of water and dissolved dyes in dying industries, culture and filtration of animal cells, pretreatment filtration in pure water production processes using RO membranes (including desalination of seawater), pretreatment filtration in processes that use ion exchange membranes, and pretreatment filtration in pure water production processes using ion exchange resin.

In water purification treatment, the filtration apparatus 1 can be used in combination with powdered activated carbon. First, minute dissolved organic matter is adsorbed by the powdered activated carbon, and water containing powdered activated carbon adsorbing the dissolved organic matter is filtrated with the filtration apparatus 1 so as to efficiently perform water purification treatment.

In sewage treatment, a tank in which bacterial cells are grown can be used in combination. Sewage is introduced into the tank, and contaminants in the sewage are decomposed by the bacterial cells and cleaned. The resulting sewage containing the bacterial cells is then filtrated by the filtration apparatus 1 to efficiently perform sewage treatment.

### [Other Embodiments]

The embodiments disclosed herein should be considered illustrative in all respects and not limiting. The scope of the present invention is not limited by the features of the embodiments described above but is intended to include all modifications and alterations within the meaning and scope of the claims and their equivalents.

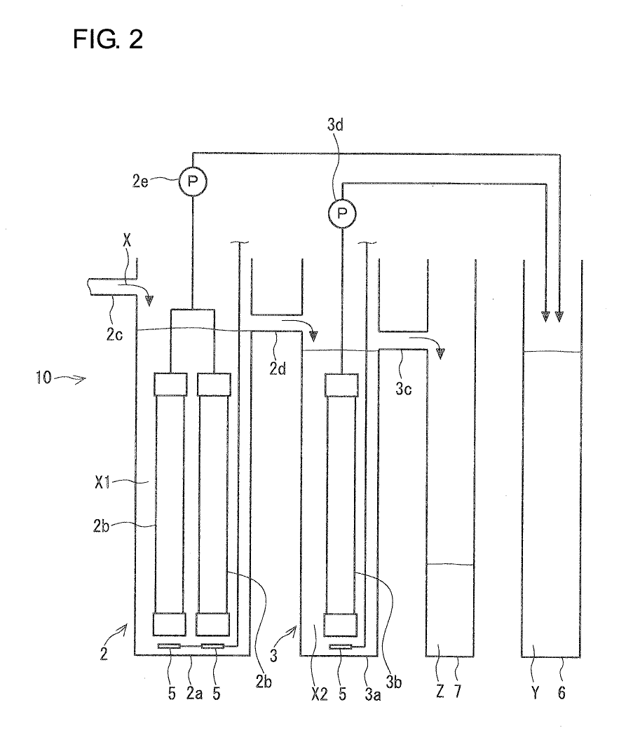

In the embodiments described above, a filtration apparatus that has three filtration units, namely, the first filtration unit, the second filtration unit, and the third filtration unit, is described but the scope of the present invention is not limited to this. In other words, a filtration apparatus that has only two filtration units, namely, a first filtration unit 2 and a second filtration unit 3 as in a filtration apparatus 10 illustrated in FIG. 2, is also within the intended scope of the present invention. Alternatively, the filtration apparatus may include four or more filtration units.

The overflow pipe installed between an upstream filtration vessel and a downstream filtration vessel or storage vessel, namely, between the first filtration vessel and the second filtration vessel, between the second filtration vessel and the third filtration vessel, or between the third filtration vessel and the concentrated liquid storage vessel, can be omitted. For example, the first filtration vessel and the second filtration vessel may be installed to be in contact with each other and holes that communicate to each other may be formed at the overflow positions of the respective vessels to form an overflow line.

Although a structure and a method of supplying a liquid to be treated from an upstream filtration vessel to a downstream filtration vessel or storage vessel, namely, from the first filtration vessel to the second filtration vessel, from the second filtration vessel to the third filtration vessel, and from the third filtration vessel to the concentrated liquid storage vessel, by causing overflow are described in the embodiments above, the method for supplying the liquid to be treated to the respective vessels is not limited to causing overflow. For example, a pipe that connects vessels and a transfer pump may be provided between the vessels and the liquid to be treated may be supplied from one vessel to the other vessel by using the transfer pump.

Moreover, in the embodiments described above, a method of suctioning the liquid by using a pump while leaving an upper end of each filtration vessel open is described as an example. Alternatively, each filtration vessel may be a sealed container, and the treated liquid may be drained from each filtration membrane module by an external pressure generated by pressurization instead of suction.

The total filtration area of the second filtration unit is not necessarily smaller than the total filtration area of the first filtration unit. When the total filtration area of the second filtration unit is to be smaller than the total filtration area of the first filtration unit, the size and type of the filtration membrane modules may be changed instead of changing the number of filtration membrane modules. Moreover, one filtration membrane module may be installed inside the first filtration vessel, and plural filtration membrane modules may be installed inside the second filtration vessel or the third filtration vessel.

The air bubble supplying units of the filtration apparatus can be omitted.

### Industrial Applicability

As described above, the filtration apparatus of the present invention has excellent treatment efficiency and cost performance. Accordingly, the filtration apparatus and the immersion-type filtration method are suitable for use as solid-liquid separation treatment apparatuses in a variety of fields.

### Reference Signs List

1, 10 filtration apparatus

2 first filtration unit

2a first filtration vessel

2b first filtration membrane modules

2c liquid supplying pipe

2d first overflow pipe

2e first pump

3 second filtration unit

3a second filtration vessel

3b second filtration membrane module

3c second overflow pipe

3d second pump

4 third filtration unit

4a third filtration vessel

4b third filtration membrane module

4c third overflow pipe

4d third pump

5 air bubble supplying unit

6 treated liquid storage vessel

7 concentrated liquid storage vessel

X, X1, X2, X3 liquid to be treated

Y treated liquid

Z concentrated liquid

1. A filtration apparatus of an immersion type that purifies a liquid to be treated by using a filtration membrane, the filtration apparatus comprising a plurality of filtration units each comprising a filtration vessel and at least one filtration membrane module immersed in the filtration vessel, the filtration units being arranged in series.

2. The filtration apparatus according to claim 1, wherein a liquid to be treated is supplied from an upstream filtration unit to a downstream filtration unit among the plurality of filtration units by causing the liquid to be treated to overflow.

3. The filtration apparatus according to claim 1, further comprising an air bubble supplying unit that supplies air bubbles from under the filtration membrane module.

4. An immersion-type filtration method that uses the filtration apparatus according to claim 1, comprising supplying a portion of a liquid to be treated in an upstream filtration unit to a downstream filtration unit among the plurality of filtration units so as to purify the liquid to be treated.

5. An immersion-type filtration method that uses the filtration apparatus according to claim 2, comprising supplying a portion of a liquid to be treated in an upstream filtration unit to a downstream filtration unit among the plurality of filtration units so as to purify the liquid to be treated.

6. An immersion-type filtration method that uses the filtration apparatus according to claim 3, comprising supplying a portion of a liquid to be treated in an upstream filtration unit to a downstream filtration unit among the plurality of filtration units so as to purify the liquid to be treated.
